(19) United States
(12) Patent Application Publication
(10) Pub. No.: US 2011/0129185 A1
(43) Pub. Date: Jun. 2, 2011

(54) Articulated Strain Relief Boot on a Fiber Optic Module and Associated Methods

(76) Inventors: C. Paul Lewallen, Hudson, NC (US); James P. Luther, Hickory, NC (US); Stuart R. Melton, Hickory, NC (US); Martin E. Norris, Lenoir, NC (US); Thomas Theuerkorn, Hickory, NC (US)

(21) Appl. No.: 12/946,139

(22) Filed: Nov. 15, 2010

Related U.S. Application Data
(60) Provisional application No. 61/265,038, filed on Nov. 30, 2009.
(60) Provisional application No. 61/265,047, filed on Nov. 30, 2009.

(51) Int. Cl. G02B 6/36

(52) U.S. Cl. 385/53; 385/134

(57) ABSTRACT

A factory finished fiber optic module assembly that may be pulled from a first location to a second location by a pulling means, the module assembly having a pulling feature. The assembly may further be installed directly into a mounting structure for use with other like assemblies as a patch panel. The fiber optic module assembly may be installed in a vertical orientation facilitated by an articulated strain relief boot assembly that pivots and rotates for cable management, which reduces the vertical footprint of the fiber optic module assembly. High density embodiments of the fiber optic module assembly may be connected to the rear or side of a mounting structure for optical connection to pigtailed modules. The fiber optic module assembly may have a modular connector interface for mating dissimilar fiber optic connector assemblies.

### PRIORITY APPLICATION

This application claims the benefit of U.S. Provisional Application Ser. No. 61/265,038 filed on Nov. 30, 2009 and entitled “Articulated Strain Relief Boot on a Fiber Optic Module and Associated Methods,” the entire contents of which are hereby incorporated by reference.

### RELATED APPLICATION

The present application is related to U.S. Provisional Application Ser. No. 61/265,047 filed on Nov. 30, 2009 and entitled “Fiber Optic Module Assembly and Associated Methods,” the entire contents of which are hereby incorporated by reference.

### FIELD

The disclosure relates generally to fiber optic assemblies and more particularly to fiber optic module assemblies which may be used in fiber optic assemblies.

### TECHNICAL BACKGROUND

Telecommunications systems use data centers to collect, process and redistribute large amounts of electronic and digital information. Fiber optics has ushered in a faster and more efficient means of performing this basic function, enabling smaller data centers to perform at higher capacities than conventional copper based systems. Design of fiber optic based data centers reflects this capability of small area to high capacity. Consequently, cramped data centers are more the rule than the exception. Routing of cables, arrangement of racks and hierarchy of shelves are considerations that the data center designer must contend with using smaller and smaller spaces.

A typical data center receives trunk cables into a Main Distribution Area (MDA) where the signals are usually split using optical splitters and sent forward via high fiber count cables. High fiber count cabling in the MDA is sent to a Zone Distribution Area (ZDA) where the signals are redistributed and fiber counts are reduced, and sent on to an appropriate region or zone of an Equipment Distribution Area (EDA), and from there the signals are sent to end user interface. Sometimes, in smaller data centers, the signals are sent directly from the MDA to the EDA, bypassing a ZDA altogether.

Raceways for routing cables above rack mounted hardware and subfloors for routing cables below rack mounted hardware are commonplace in this architecture and provide acceptable solutions for cable overcrowding. However, a fully populated data center can present a challenge for moves, adds and changes. More capacity and updated hardware are frequently needed and can be difficult to install, increasing downtime and expense. A fiber optic module assembly that facilitates quick and easy installation from the MDA to either the ZDA or the EDA, or from the ZDA to the EDA, is needed to keep costs and installation time to a minimum.

### SUMMARY

In one embodiment, the disclosure is directed to a fiber optic module assembly, defining a pulling feature. The fiber optic module assembly has a housing assembly receiving a portion of a fiber optic cable assembly and receives a plurality of fiber optic connectors for optically mating to a plurality of optical connector assemblies on the fiber optic cable assembly. The pulling feature facilitates installation of the fiber optic module assembly. In other embodiments the fiber optic module assembly further includes a latching feature for attaching the fiber optic module assembly to a mounting structure.

Another embodiment of the disclosure is directed to a fiber optic module assembly having a modular connector interface assembly that optically mates similar or dissimilar optical connector assemblies. The modular connector interface assembly has interchangeable components that have differing adapter features for custom connector mating configurations.

The disclosure is further directed to a fiber optic module assembly having an articulated strain relief boot that pivots and rotates to facilitate attachment and cable management.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a fiber optic module assembly;

FIG. 2 is a partially exploded view of the fiber optic module assembly of FIG. 1;

FIG. 3 is a partially assembled, perspective view of the fiber optic module assembly of FIGS. 1 and 2 having a housing cover portion removed;

FIG. 4 is a side profile view of the fiber optic module assembly of FIG. 1;

FIG. 5 is a partial cross-sectional detail of the embodiment of FIG. 4 revealing dissimilar optical connector assemblies mating across components of a modular connector interface assembly;

FIG. 6 is a perspective view of a modular connector interface assembly of FIGS. 1-5;

FIGS. 7A-7B are two perspective views of a first connector interface plate;

FIGS. 8A-8B are two perspective views of a second connector interface plate;

FIG. 9 is an embodiment of an installation scheme having the fiber optic module assembly of FIG. 1 installed on a side of a mounting structure;

FIG. 10A-10B depict an alternate embodiment of a fiber optic module assembly having an optical connector-adapter assembly with a close-up view of an articulated strain relief boot;

FIGS. 11A-11B show the fiber optic module assembly of FIGS. 10A and 10B installed on a mounting structure having a swing-out panel;

FIG. 12 is the optical connector-adapter assembly of FIG. 10A;

FIG. 13 is a cross-sectional view of the optical connector-adapter assembly of FIG. 12;

FIG. 14A is an optical connector-adapter half of the optical connector-adapter assembly of FIG. 12;

FIG. 14B is an optical connector-adapter insert of the optical connector-adapter assembly of FIG. 12;

FIG. 15A-15B depict another fiber optic module assembly having an articulated strain relief boot and a protective cover;

FIG. 16 shows still another fiber optic module assembly featuring the articulated strain relief boot in a perpendicular orientation;

FIGS. 17A-E are various embodiments of fiber optic cable assemblies attached to the fiber optic module assembly;

FIG. 18 schematically depicts a high fiber count trunk cable furcated into fiber optic module assemblies; and

FIG. 19 schematically depicts another high fiber count trunk cable furcated into fiber optic module assemblies.

### DETAILED DESCRIPTION

Reference will now be made in detail to various embodiments of the fiber optic module assembly, examples of which are illustrated in the accompanying drawings. Whenever possible, like reference numbers will be used to refer to like components or parts.

The disclosure herein is to a fiber optic module assembly having at least one fiber optic cable assembly, a housing assembly for receiving a portion of the fiber optic cable assembly and a pulling feature. Typically, the craft pulls the fiber optic module assembly from a first location to a second location to facilitate installation. For instance, the first and second locations may be a Main Distribution Area (MDA), a Zone Distribution Area (ZDA) or an Equipment Distribution Area (EDA) in a data center. In some embodiments the first location may be a region in a data center and the second location may be removed from the data center and more proximate to an end user, such as a mounting structure in a Network Interface Device (NID) closet located on a different floor or in a different part of a building, requiring the use of vertical or horizontal ducts. In some embodiments, the fiber optic module assemblies may be pulled through ducts having a cross sectional area of 9 square inches (about 58 square centimeters) or greater from a first location to a second location. This area represents a cylindrical duct size of 3 inches (about 7.62 centimeters) inner diameter. Embodiments of the fiber optic module assembly may also be pulled along raceways and through subfloors in a data center, further enabling installation. To aid the craft, the fiber optic module assembly disclosed may include a pulling feature, as disclosed herein.

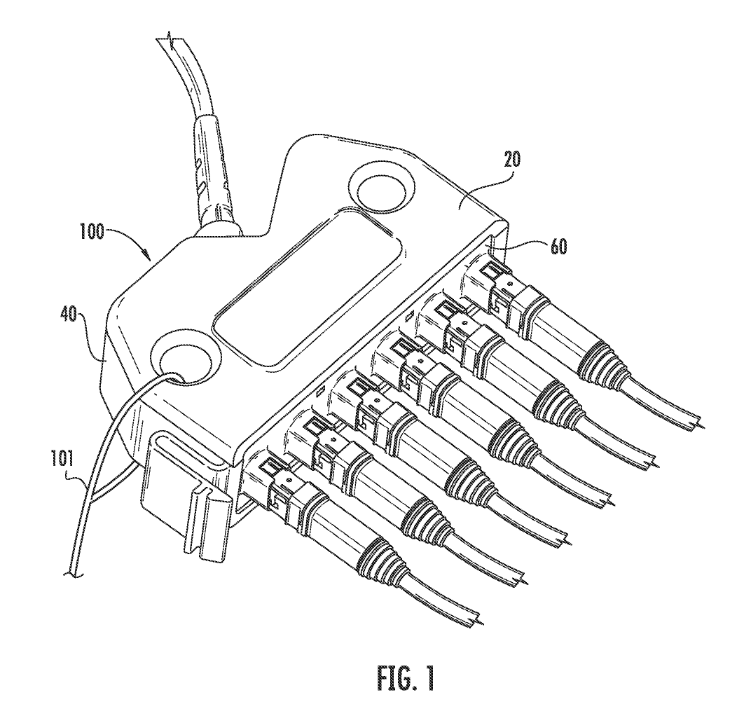

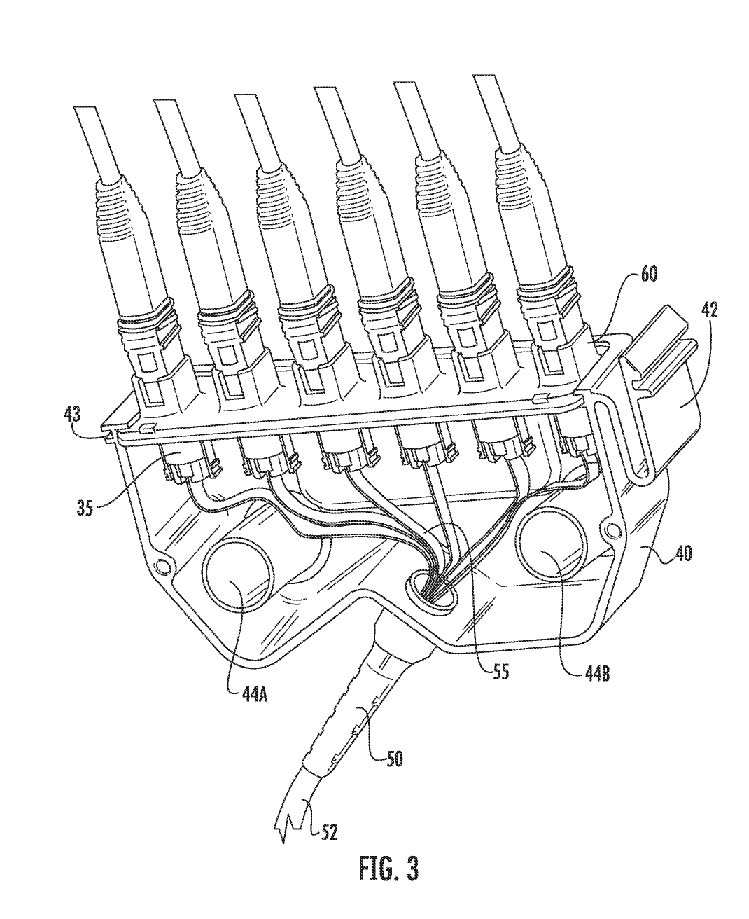

FIG. 1 is an embodiment of a fiber optic module assembly 100 having a housing cover portion 20, a housing receiving portion 40 and a modular connector interface assembly 60 that cooperate to define a housing assembly. Fiber optic module assembly 100 has a pulling means 101 attached to a pulling feature (not numbered) for pulling the fiber optic module assembly 100 from a first location to a second location. Pulling means 101 in the embodiment of FIG. 1 is a tape, but in other embodiments the pulling means can be a strap, a lanyard, a wire, a cable, or the like. As best shown in FIG. 4, the pulling feature may be a through aperture pulling features 45A and 45B.

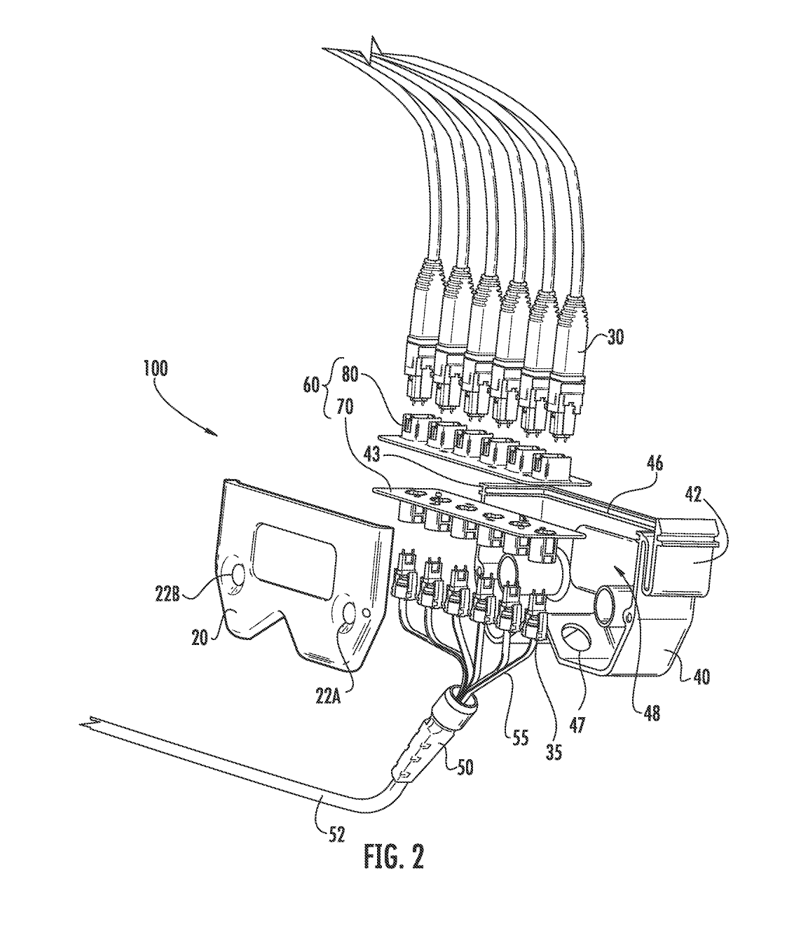

Further, FIGS. 1-3 show at least one fiber optic cable assembly comprising a fiber optic cable 52, at least one optical fiber 55 and at least one optical connector assembly 35 may be fed through a cable receiving feature 47 into an interior cavity 48. The interior cavity 48 may be at least partially defined by housing receiving portion 40. Interior cavity 48 may be further defined by housing cover portion 20 and modular connector interface assembly 60. A strain relief boot 50 is secured about fiber optic cable 52 and affixed to housing receiving portion 40 at the cable receiving feature 47. FIG. 2 also shows least one fiber optic connector assembly 30 plugged into a component of modular connector interface assembly 60. At least one optical connector assembly 35 may be plugged into another component of modular connector interface assembly 60 within interior cavity 48. Housing cover portion 20, housing receiving portion 40 and housing connector interface assembly 60 may be made of any suitable material, such as a polymer or a metal, and manufactured by any suitable process, such as injection molding, vacuum forming, machining, stamping and the like.

Referring to FIGS. 2-4, through aperture pulling features 45A and 45B are at least partially defined by mating the housing cover portion 20 to the housing receiving portion 40, more specifically mating a first hollow structure (44A and 44B) attached to an interior surface of the housing receiving portion 40 to a second hollow structure (22A and 22B) attached to an interior surface of the housing cover portion 20. The inner surfaces of the first (44A and 44B) and second (22A and 22B) hollow structures align and are in communication with a respective exterior surface of housing receiving 40 and housing cover 20 portions, forming the through aperture pulling features 45A and 45B. The first (44A and 44B) and second (22A and 22B) hollow structures may further serve as routing features for optical fibers. A method of employing the pulling feature may be to push a fish tape from a second location, through an access portal, such as a duct, raceway or a subfloor to a first location. The fish tape may be secured to the fiber optic module assembly pulling feature, then the fish tape may be pulled from the first location, through the access portal to the second location until the secured fiber optic module assembly emerges. Other methods are possible and are in keeping with the scope of this disclosure.

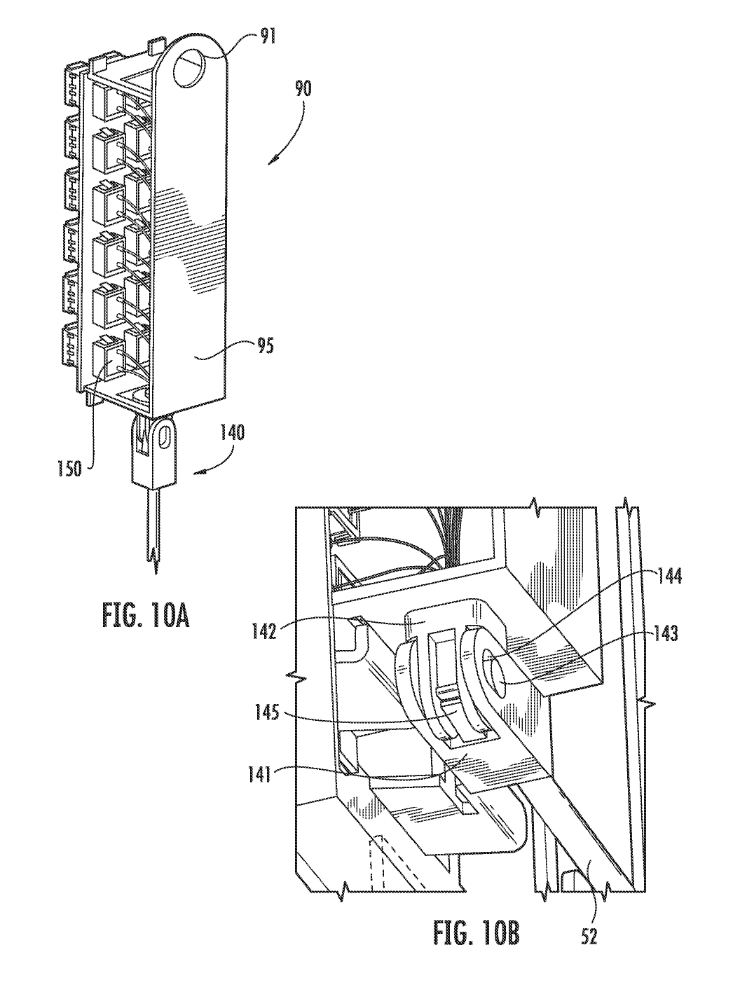

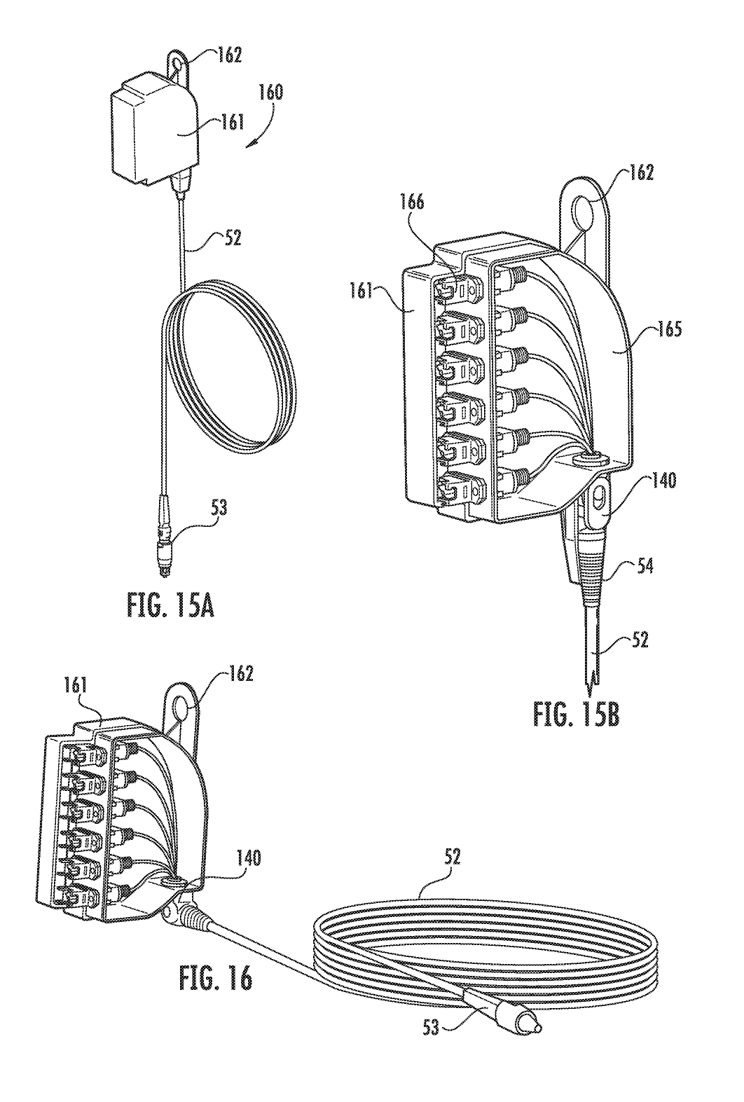

Other embodiments of the pulling feature are possible, such as shown in FIG. 10A and FIG. 15A. Specifically, FIG. 10A shows a loop pulling feature 91 defined by another embodiment 90 of a fiber optic module assembly and FIG. 15A shows cover pulling feature 162 defined by a protective cover 161 on a further embodiment 160 of a fiber optic module assembly. Consequently, the pulling feature for the fiber optic module assembly may include a loop, a hook and a through aperture and may be incorporated on any of the embodiments.

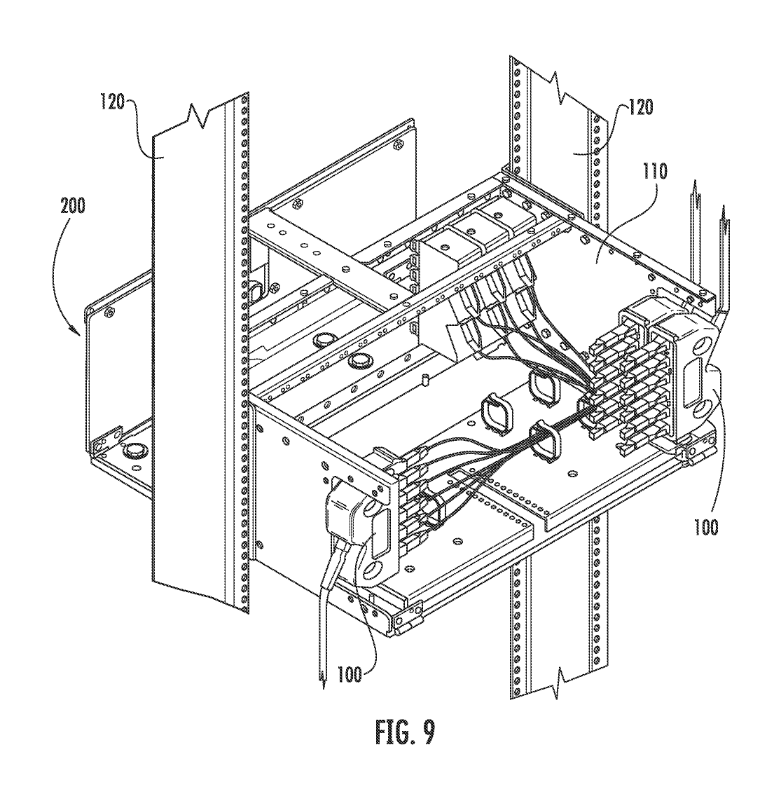

The fiber optic module assembly of the disclosure may be attached directly to any suitable mounting structure. The mounting structure may be a bracket, a box, a raceway, or the like. By way of example, the mounting structure may be a rack mounted shelf in a data center, such as a Pretium™ Rack-mountable 4U Housing, commercially available from Corning Cable Systems, LLC, Hickory N.C., for use with other fiber optic module assemblies as a patch panel. In some embodiments the fiber optic module assembly may be attached to the side or back of the rack mounted shelf to provide an optical interface for pigtailed interconnect assemblies mounted on the front of the shelf as shown in FIG. 9. Additionally, the fiber optic module assembly may be installed in a vertical or a horizontal orientation.

In some embodiments the fiber optic module assembly may include a latching feature for attaching to the mounting structure. As seen in FIGS. 2-5 an embodiment of the latching feature 42 may be a flexible latching member and stationary latching channel 43 defined by the housing receiving portion 40, which cooperate to engage an appropriate aperture for securing the fiber optic module assembly. For instance, the latching feature of the fiber optic module assembly may engage a rectangular opening on a data center shelf, to attach the fiber optic module assembly 100 at the desired location. FIG. 4 shows a side view of fiber optic module assembly 100 providing a profile view of flexible latch member 42 and stationary latching channel 43.

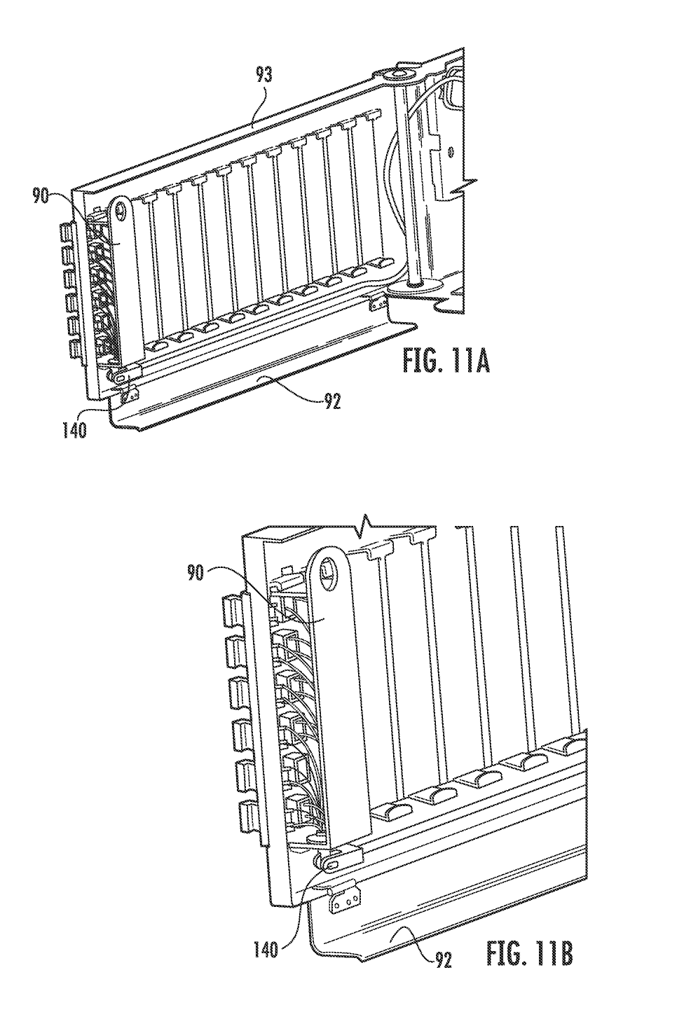

A method of attaching of the fiber optic module assembly 100 may be to fit the stationary latching feature 43 over a first sheet or panel. The fiber optic module assembly 100 may then be pivoted forward to flexibly engage the latching feature 42 until it engages a second sheet or panel that is a suitable distance from the first sheet or panel. Attachment of the fiber optic module assembly 100 may be in the front or rear of the shelf (see FIG. 9 and FIGS. 11A-11B) depending upon configuration of the module assembly and the requirements of the datacenter. The attachment means may further be a discrete component such as a hook, a push clip, or a strap.

The module assembly may be installed vertically, horizontally, or any suitable orientation in the front or rear of the mounting structure. FIG. 9 shows a 4U data center shelf assembly 200 having a 4U data center shelf 110 mounted in a data center rack 120. Multiple fiber optic module assemblies 100 are shown mounted on the side of shelf 110 with the modular connector interface assembly 60 facing into the shelf and the fiber optic cable 52 and strain relief boot 50 outside of the shelf. In this embodiment the fiber optic module assemblies 100 provide an optical interface for forward facing modules by connectorized pigtails coming from the forward facing modules, the module assemblies having six, twelve or twenty-four fiber count connectors each, for a total fiber count of 72 to 144 fibers in each module assembly. Twelve fiber optic module assemblies 100 may be installed in the front of the 4U data center shelf.

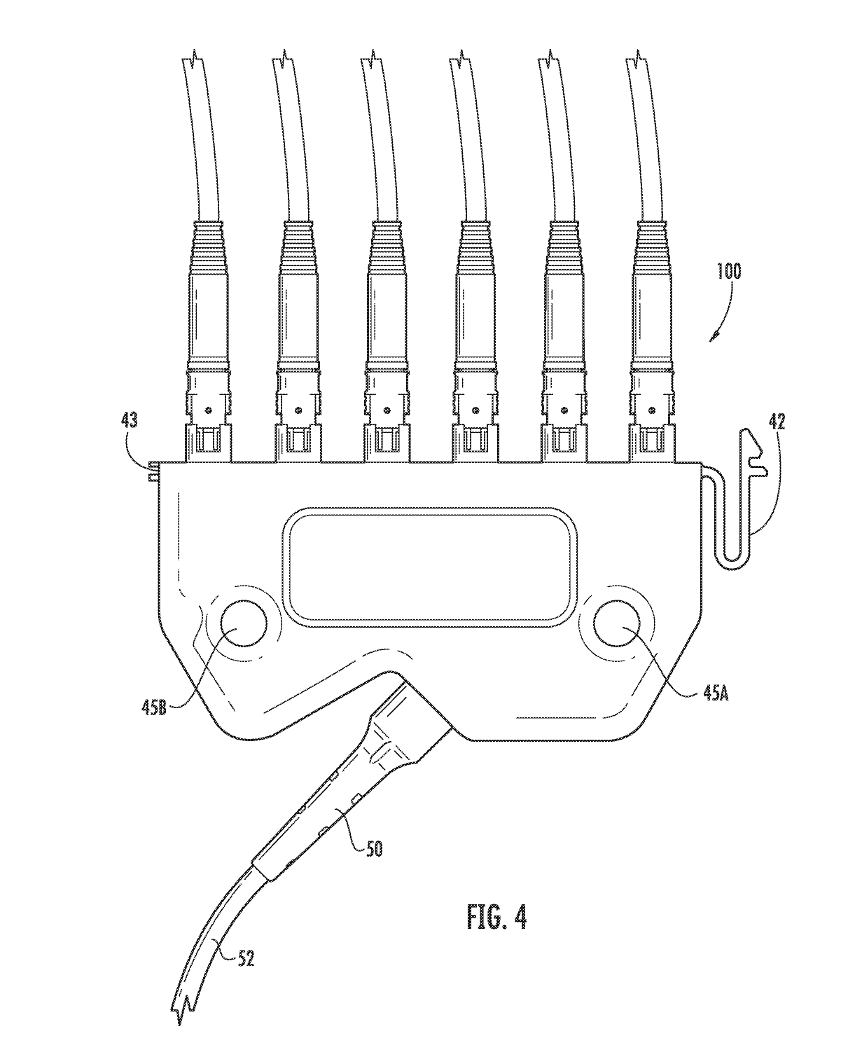

Another aspect of the disclosure is the modular connector interface assembly 60. The fiber optic module assembly 100 removably receives the modular connector interface assembly 60. The modular connector interface assembly 60 receives and optically mates optical connector assemblies. In some embodiments the modular connector interface assembly 60 receives and optically mates dissimilar optical connector assemblies as seen in FIGS. 2 and 5. The modular connector interface assembly 60 has connector interface features that receive custom optical connector assemblies to keep the housing assembly small, further enabling pulling through ducts, raceways, etc. Simply stated, the fiber optic module assembly has a relatively small cross section to enable pulling into tight spaces.

FIG. 2 is a partially exploded view of the fiber optic module assembly 100 of FIG. 1. Housing cover portion 20 serves as a lid or cover and may be shaped to conform to housing receiving portion 40. Housing cover portion 20 may be secured by a securing means, such as latch tabs or screws (not pictured). The modular connector interface assembly 60 from FIG. 1 has at least a first connector interface plate 70 and a second connector interface plate 80. Both plates may be snapped together or interlocked, forming the modular connector interface assembly 60 that may be received by a channel receiving means 46 defined by the housing receiving portion 40. FIG. 3 shows the fiber optic module assembly with cover portion removed and shows modular connector interface assembly 60 residing in the channel receiving means 46. As shown in FIG. 2, the channel receiving means 46 follows an inner edge of the housing receiving portion 40. Other means of receiving the modular connector interface assembly 60 are possible, such as latches and clips, and are within the scope of this disclosure.

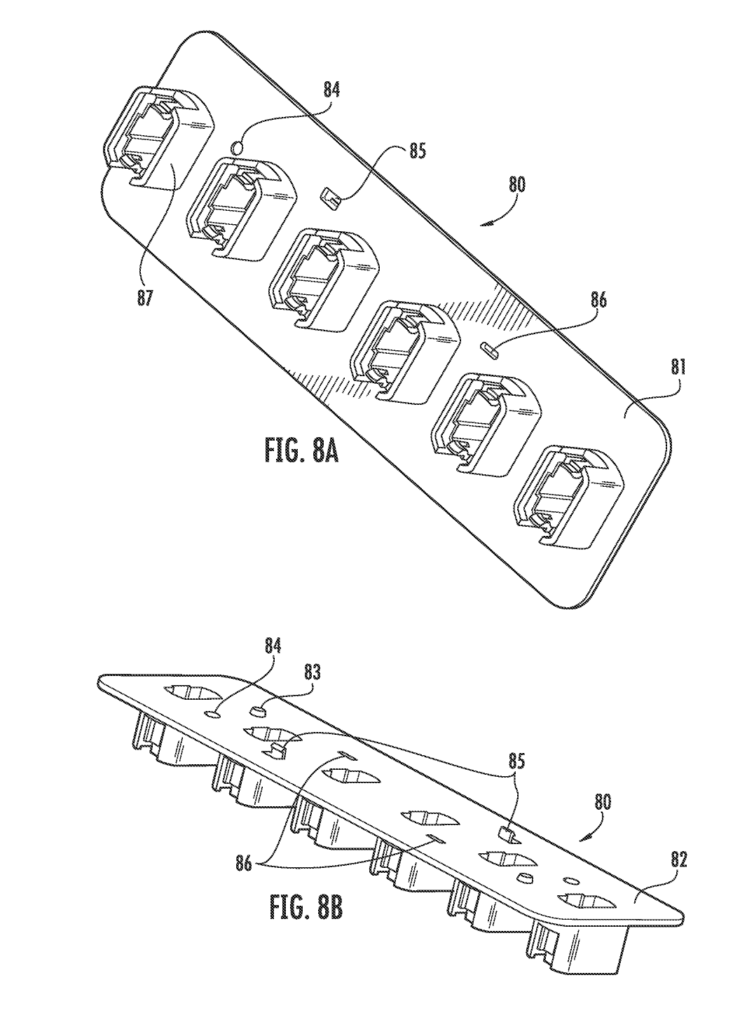

FIG. 5 depicts a partial cutaway view of fiber optic module assembly 100. FIG. 5 highlights the mating of dissimilar optical connector assemblies, namely optical connector assembly 35 and fiber optic connector assembly 30. Optical connector assembly 35 has a multi-fiber ferrule 36, a ferrule boot 34, an alignment cuff 33, a force translation spring 32 and retention clip 31. The optical connector assembly may be attached to an optical fiber ribbon 55 such that it may be optically mated to a fiber optic connector assembly 30. As shown in FIGS. 1-5, fiber optic connector assembly 30 may be an MTP connector, though other fiber optic connector assemblies are possible, such as MPO, LC, LC duplex, SC, SC duplex, and DC fiber optic connector assemblies. As shown in FIG. 8A, connector interface plate 70 has adapter features, to engage the optical connector assembly 35 such that it may optically mate to fiber optic connector assembly 30. A modular connector interface assembly 60 in other embodiments may have apertures to receive duplex or simplex adapter assemblies.

FIG. 6 shows modular connector interface assembly 60 in more detail. The FIG. 6 depicts the first connector interface plate 70 interlocked with the second connector interface plate 80. Having two distinct plates allows different connector mating schemes for mating similar or dissimilar optical connector assemblies. The modular connector interface assembly 60 of the disclosure acts as the connective interface for optically connecting fiber optic connector assemblies. In yet other embodiments, the first and second connector interface plates are substantially identical to accept substantially similar optical connector assemblies.

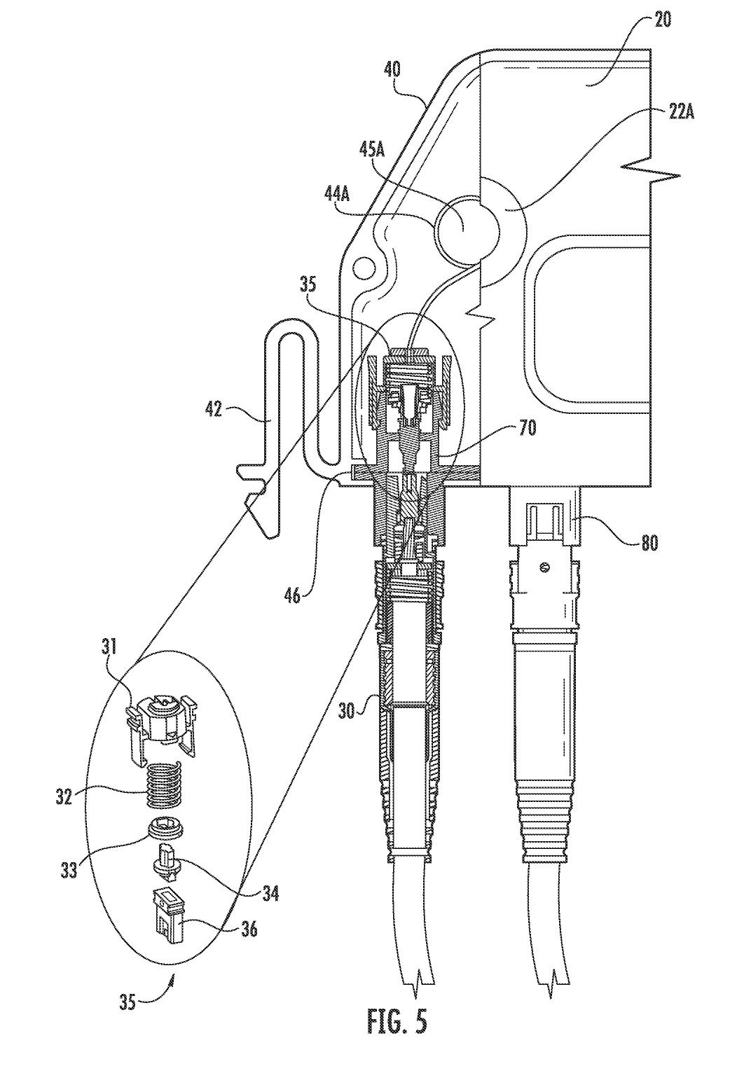

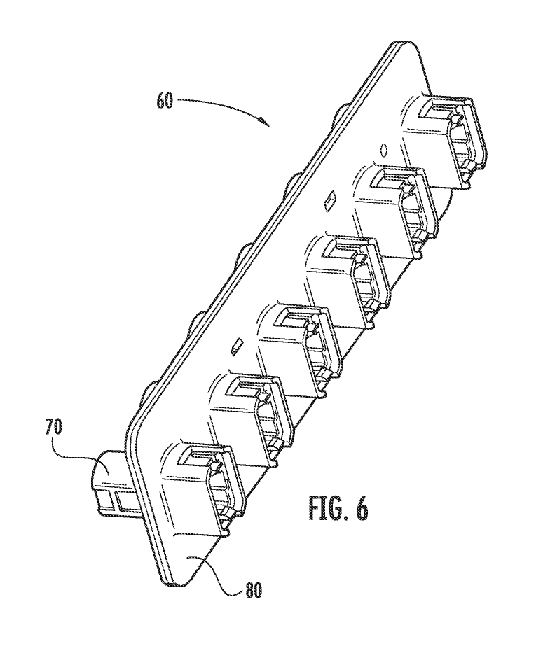

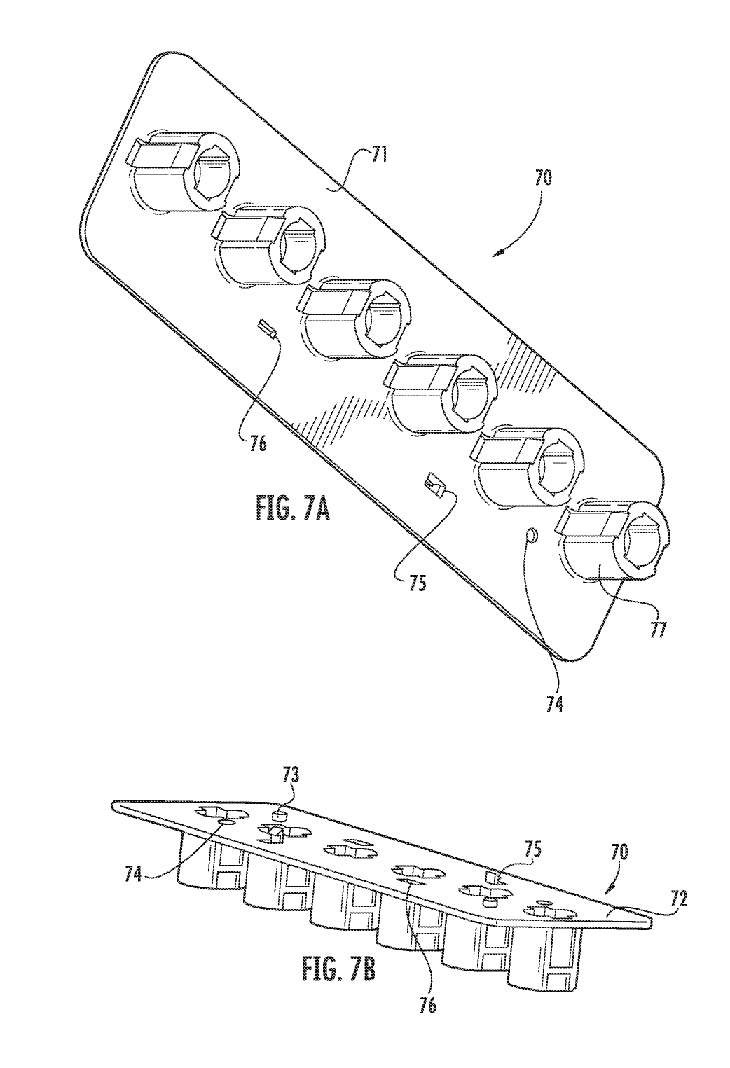

FIGS. 7A-7B show two perspective views of the first connector interface plate 70 configured to accept optical connector assembly 35. FIGS. 8A-8B show two perspective views of the second connector interface plate 80. Corresponding elements for each are, respectively: connector interface sides 71, 81, for directly interfacing with optical connector assembly 35 or fiber optic connector assembly 30; plate interface sides 72, 82, for joining the two plates together for forming housing connector interface assembly 60; alignment protrusions 73, 83 and alignment cavities 74, 84 that cooperate to axially align first connector element 77 to second connector element 87. Additionally, respective plate latches 75, 85 cooperate with respective plate latch apertures 76, 86 to securely fasten the two plates together by interlocking the plate interface sides 72 and 82.

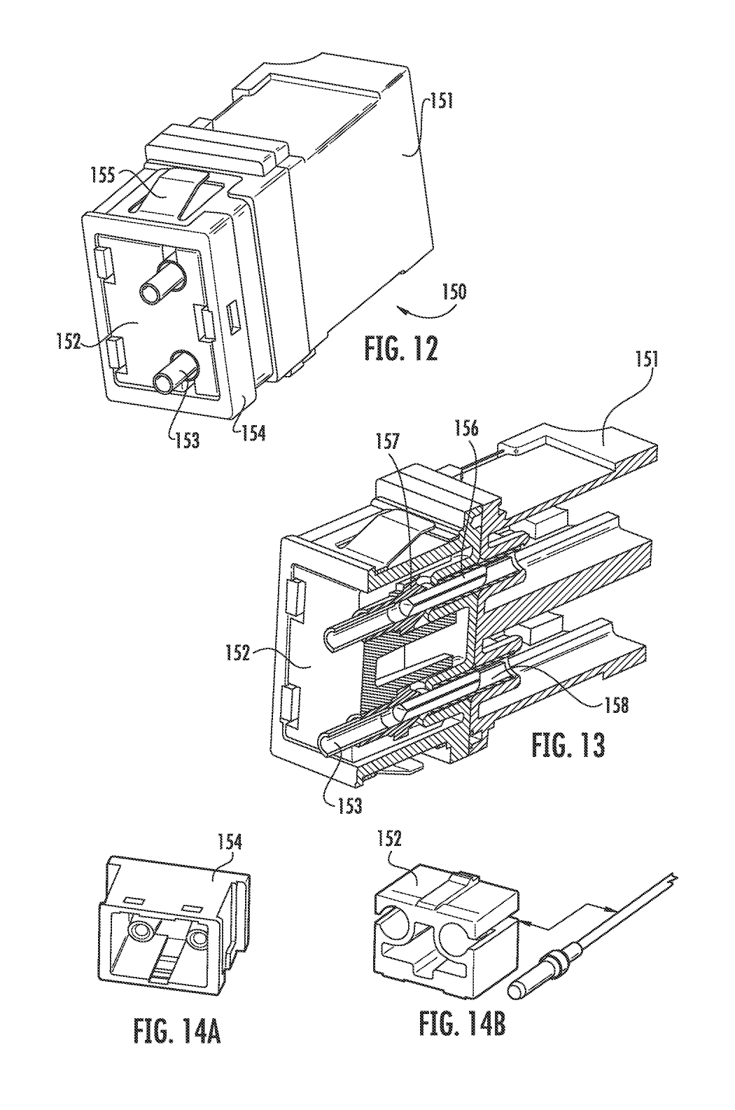

Modular connector interface assembly 60 may be an aperture plate defined by the housing receiving portion 40 for receiving a plurality of adapter assemblies. FIGS. 10A and 10B shows smaller alternate housing receiving portion 95 housing a plurality of optical connector-adapter assemblies 150. FIGS. 12 and 13 show the optical connector-adapter assembly 150, the assembly comprising a connector-adapter housing assembly, formed from mating a duplex adapter half 151 and an optical connector-adapter half 154. The optical connector-adapter assembly houses an optical connector-adapter insert 152 and a pair of ceramic ferrule alignment sleeves 158. A pair of ferrules 156 in ferrule holders 157 are encased within the optical connector-adapter insert. Fiber protective sleeve 153 facilitates receiving an optical fiber. For example, the ferrules in this embodiment are LC ceramic ferrules, though other single fiber ferrules are within the scope of this disclosure. Ferrules 156 are inserted into the ceramic alignment sleeves 158 for axially aligning with corresponding ferrules from optical connector assemblies. An adapter retention clip 155 holds the optical connector-adapter assembly 150 within an aperture in the smaller alternate housing receiving portion 95.

However, in other embodiments the modular connector interface assembly 60 may have apertures to accept duplex or simplex adapters in a more conventional arrangement as shown in FIG. 11A to FIG. 16.

Another aspect of the disclosure is directed to a fiber optic module assembly including an articulated strain relief boot. As shown in FIG. 10A, the articulated strain relief boot may be on an opposite end from the pulling feature to further enable pulling the fiber optic module assembly during installation by transferring a pulling force through the housing assembly to the articulated strain relief boot. A mounting structure having limited vertical attachment space will benefit from the fiber optic module assembly having an articulated strain relief boot that pivots or bends near the housing assembly This reduces the effective vertical footprint of the fiber optic module assembly while maintaining linear alignment for pulling. Further, by also rotating around an axis of egress into the housing assembly, the articulated strain relief boot assists the craft in placing the fiber optic cable in a more advantageous position for cable management. This may be further facilitated by use of bend insensitive fiber, such as ClearCurve® Multimode fiber, commercially available from Corning Incorporated, as well as other optical fibers having improved bending performance.

Front attachment of an embodiment of a fiber optic module assembly having an articulated strain relief boot 140 is shown in FIG. 10A. Articulated strain relief boot 140 in this embodiment has a module portion for engaging the fiber optic module assembly and a cable portion for engaging the fiber optic cable. The module portion pivots relative to the cable portion at a pivot point. A pulling force applied to the pulling feature, shown in FIG. 10A to be a loop pulling feature 91, may be directed linearly through a long axis of the fiber optic module assembly to the fiber optic cable assembly. A smaller alternate housing receiving portion 95 houses a plurality of optical connector-adapter assemblies 150. FIG. 10B shows detailed view of the articulated strain relief boot 140, which may be an articulated strain relief boot 140 assembly having a cable component 141 and a module component 142. Cable component 141 may be attached to fiber optic cable 52 and has pivot point 143 that attaches to a translation slot 144 found on the module component 142. Pivot point 143 resides in the translation slot 144. An articulated boot lock latch 145 provides a locking detent to stop and lock bending at about 90 degrees (installed position). Once released, articulated boot lock latch 145 allows cable component 141 to translate the length of translation slot 144 axially in line with the fiber optic cable, whereby it can freely bend until the assembly is substantially straight (pulling position). The articulated strain relief boot 140 provides a pivotable conduit or through passage for the optical fibers therein and does not allow the optical fibers inside to bend below a minimum bend radius for the optical fiber used. The optical fibers residing inside the pivotable conduit may translate into and out of the interior cavity as the articulated strain relief boot pivots. Module component 142 may be secured to cable receiving feature 47 and rotates in a limited arc, from 0 degrees to about 360 degrees and back to 0 degrees, thereby preventing overly twisting the optical fibers and causing physical damage to the optical fibers therein.

FIGS. 11A and 11B show two views of an alternate embodiment 90 of the fiber optic module assembly mounted on a front of a mounting structure, in this embodiment a 4U data center shelf with a swinging front panel 93 (further enabled by bend insensitive optical fiber). Alternate embodiment 90 may have the articulate strain relief boot 140 assembly attached to the swinging front panel 93, with articulated strain relief boot 140 in the installed position. Cable gather 92 prevents fiber optic cable 52 from dangling below the level of the floor of the 4U data center shelf.

Another 160 fiber optic module assembly is shown in FIG. 15A having fiber optic cable 52 connectorized by rugged connector 53. FIG. 15B reveals the interior 165 of another 160 fiber optic module assembly having partial MTP connectors installed within MTP adapters 166. Articulated strain relief boot 140 may be housed by protective cover 161 and is shown in the pulling position. A flexible strain relief boot 54 may be attached to articulated strain relief boot 140 to further enhance strain relief to the fiber optic cable. FIG. 16 shows the further alternate embodiment 160 with articulated strain relief boot 140 in the installed position.

Installation of any embodiment of the fiber optic module assembly, herein described using fiber optic module assembly 100, may be enhanced by the ability of the module assembly to be pulled from a first location to a second location. A pulling means may be routed through ducts, raceways and subfloors and attached to the at least one pulling feature. A pulling force may be applied on the opposite end of the pulling means for drawing the fiber optic module assembly along from a first location to a second location. Once at the second location, which may be a mounting structure, such as a rack mounted shelf, the pulling means may be removed. The articulated strain relief boot 140 may be disengaged from the pulling position and pivoted up to plus or minus 90 degrees in an appropriate direction to an installed position. This places the fiber optic cable in a more advantageous position for cable management. Additionally, the articulated strain relief boot 140 may be rotated up to 360 degrees in either a clockwise or counter-clockwise direction until the craft determines the best attitude for the particular application for cable management. The fiber optic module assembly 100 may then be attached to any suitable mounting structure. The attachment may be by a latching feature 42 defined by the fiber optic module assembly comprising a flexible latching member and stationary latching channel 43, or it may be a discrete attachment means such as a hook, a push clip, or a strap.

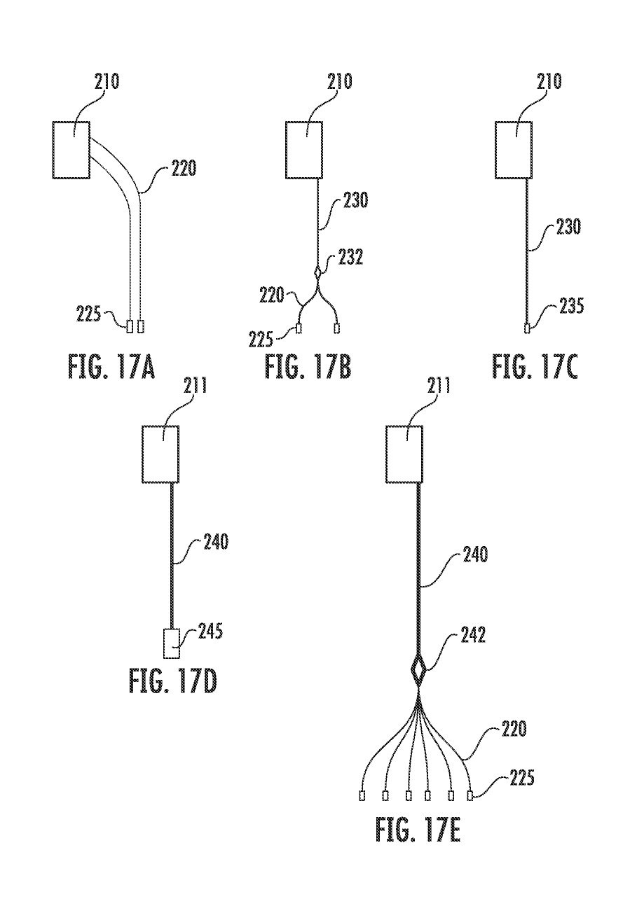

The fiber optic module assembly of the disclosure supports many cable configurations. FIGS. 17A to 17E are sample embodiments. A 24 fiber, fiber optic module assembly 210 in FIG. 17A has two 12 fiber cables 220 attached to the “rear” of the assembly, though they may exit from the “bottom” (not shown). 12 fiber optical connectors 225 are on the opposite ends of the cables 220. FIG. 17B has a 24 fiber cable 230, being furcated into two cables by 24 fiber to 12 fiber furcation 232 into two 12 fiber cables, terminated by 12 fiber connectors 225. FIG. 17C has 24 fiber cable 230 attached to the 24 fiber, fiber optic module assembly 210 and being terminated by 24 fiber connector 235. FIG. 17D has high density interconnect assembly 211 with 72 fiber cable 240 terminated by a single high density 72 fiber connector 245. FIG. 17E is similar to FIG. 17D except that 72 fiber cable 240 may be furcated into six cables by 72 fiber to 12 fiber furcation 242, each 12 fiber cable 220 being terminated by 12 fiber connector 225. The above recitation is in no way the limit of the cable configurations that may be employed by the interconnect assembly of the disclosure and other embodiments are within the scope of the disclosure.

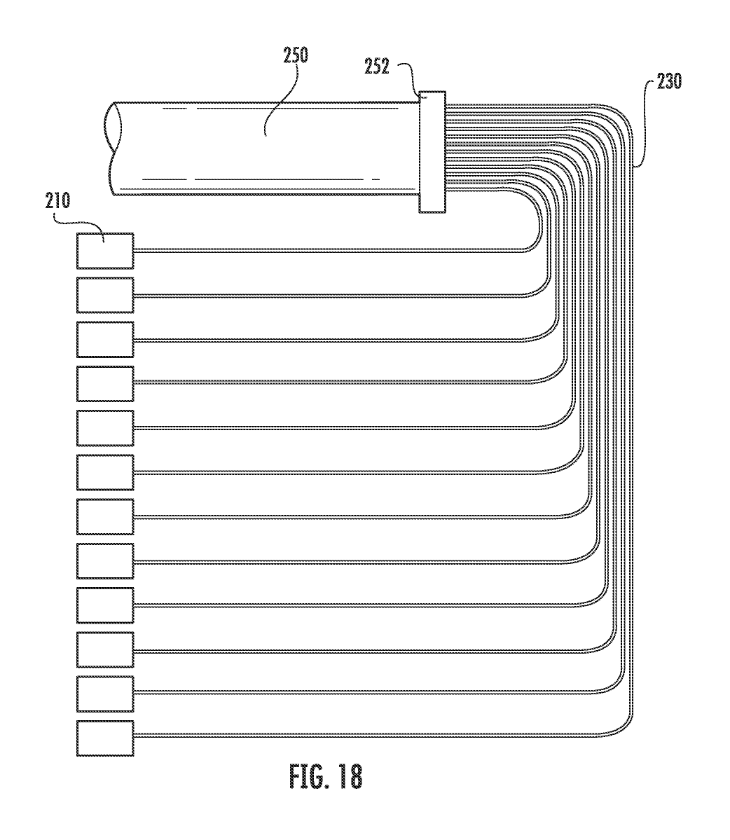

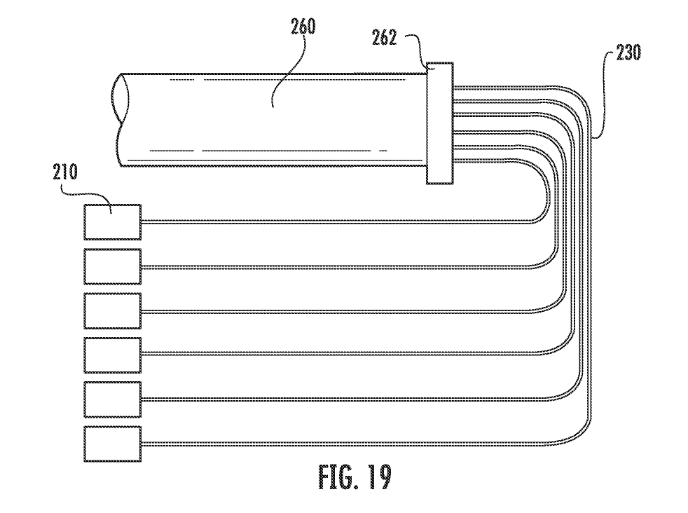

FIGS. 18 and 19 schematically show other embodiments using 24 fiber interconnect assembly 210, namely as terminations to large, furcated trunk cables. FIG. 18 has 288 fiber cable 250 with 288 fiber to 24 fiber furcation 252. The furcation results in 12, 24 fiber cables 230, each having a 24 fiber interconnect assembly 210. Similarly, FIG. 19 has a 144 fiber cable 260 with 144 fiber to 24 fiber furcation 262. The furcation results in 6, 24 fiber cables 230, each having a 24 fiber interconnect assembly 210.

It will be apparent to those skilled in the art that various modifications and variations can be made to elements of the disclosure without departing from the spirit and scope of the disclosure. Since modifications, combinations, sub-combinations and variations of the disclosed embodiments incorporating the spirit and substance of Applicant's disclosure may occur to persons skilled in the art, the disclosure should be construed to include everything within the scope of the appended claims and their equivalents.

What is claimed is:

1. A fiber optic module assembly, comprising:
a fiber optic cable assembly having a fiber optic cable, at least one optical fiber, and at least one optical connector assembly on an end of the at least one optical fiber;
a module assembly receiving the fiber optic cable assembly, wherein the module assembly attaches to a mounting structure; and
an articulated strain relief boot assembly, wherein the articulated strain relief boot assembly pivots and rotates relative to the fiber optic module assembly.

2. The assembly of claim 1, wherein the articulated strain relief boot assembly rotates up to 360 degrees relative to the module assembly.

3. The assembly of claim 1, wherein the articulated strain relief boot assembly pivots up to 180 degrees relative to the module assembly.

4. The assembly of claim 1, wherein the articulated strain relief boot assembly has at least a module component and a cable component.

5. The assembly of claim 4, wherein the cable component is secured to the fiber optic cable and pivotably fastened to the module component.

6. The assembly of claim 2, wherein the articulated strain relief boot assembly pivots from a straight uninstalled position of about zero degrees to a pivoted installed position of about 90 degrees relative to the module assembly.

7. A fiber optic module assembly, comprising:
a fiber optic cable assembly, the fiber optic cable assembly having a fiber optic cable, at least one optical fiber, and at least one optical connector assembly on an end of the at least one optical fiber;
a housing receiving portion, wherein the housing receiving portion defines an interior cavity and an exterior surface, the exterior surface defining a pulling feature on an end of the housing receiving portion and a cable aperture on a substantially opposite end of the housing receiving portion for receiving the fiber optic cable assembly into the interior cavity;
a housing cover portion;
a modular connector interface assembly, wherein the modular connector interface assembly is received by at least the housing receiving portion, the modular connector interface assembly capable of receiving a plurality of optical connectors,
at least one latching feature for attaching the fiber optic module assembly; and
an articulated strain relief boot, wherein the articulated strain relief boot assembly pivots and rotates relative to the fiber optic module assembly.

8. The assembly of claim 7, wherein the articulated strain relief boot assembly rotates up to 360 degrees relative to the module assembly.

9. The assembly of claim 7, wherein the articulated strain relief boot assembly pivots up to 180 degrees relative to the module assembly.

10. The assembly of claim 7, wherein the articulated strain relief boot assembly has at least a module component and a cable component.

11. The assembly of claim 10, wherein the cable component is secured to the fiber optic cable and pivotably fastens to the module component.

12. The assembly of claim 2, wherein the articulated strain relief boot assembly pivots from a straight uninstalled position of about zero degrees to a pivoted installed position of about 90 degrees relative to the module assembly.

13. An articulated strain relief boot, comprising:
a module portion for engaging a fiber optic module assembly;
a cable portion for engaging a fiber optic cable assembly,
wherein the articulated strain relief boot pivots up to 180 degrees relative to the fiber optic module assembly.

14. The articulated strain relief boot of claim 13, wherein the articulated strain relief boot rotates up to 360 degrees relative to the fiber optic module assembly.

15. The articulated strain relief boot of claim 13, wherein the articulated strain relief boot is an articulated strain relief boot assembly including a module component pivotably attached to a cable component.

16. The articulated strain relief boot of claim 15, wherein the module component attaches to the fiber optic module assembly and the cable component pivots up to 180 degrees relative to the fiber optic module assembly.

17. The assembly of claim 15, wherein the articulated strain relief boot assembly pivots from a substantially straight position of about zero degrees to a substantially pivoted position of about 90 degrees relative to the fiber optic module assembly.

18. A method of installing a fiber optic module assembly, comprising:
attaching a pulling means to at least one pulling feature, wherein the at least one pulling feature is defined by the fiber optic module assembly;
routing the pulling means from a first location to a second location;
pulling the pulling means from the first location to the second location; and
attaching the fiber optic module assembly to a mounting structure.

19. The method of claim 18, further including the step of pivoting an articulated strain relief boot assembly.

20. The method of claim 18, further including the step of rotating an articulated strain relief boot assembly.

21. The method of claim 18, wherein the at least one pulling feature is selected from the group consisting of a loop, a hook and a through aperture.

22. The method of claim 18, further including the step of attaching the fiber optic module assembly to a mounting structure using a latching feature, wherein the latching feature is defined by the fiber optic module assembly.
